(19) United States
(12) Patent Application Publication
(10) Pub. No.: US 2006/0048814 A1
(43) Pub. Date: Mar. 9, 2006

(54) Supply unit for an application device and process for operating such a unit

(76) Inventors: Markus Albrecht, Abstatt (DE); Heiko Hahnemann, Winnenden (DE)

Correspondence Address: FACTOR & LAKE, LTD, 1327 W. WASHINGTON BLVD., SUITE 5G/H, CHICAGO, IL, 60607, US

(21) Appl. No.: 11/191,163

(22) Filed: Jul. 27, 2005

(30) Foreign Application Priority Data
Jul. 31, 2004 (DE) 102004037247.0

(51) Int. Cl. B08B 9/00; B08B 9/04; B05B 9/00

(52) U.S. Cl. 137/15.07; 15/104.05; 15/3.5; 417/219; 118/300; 239/148

(57) ABSTRACT

There are described a supply unit for an application device, in particular for a lacquer-application device, and a process for operating such a unit, with at least one pig which is capable of being conveyed in at least one pig line between at least two pig stations, and with at least one sensor for detecting the position of the at least one pig, which is connected to a control unit for controlling the supply unit. An automatically controllable pig-exchange device exhibits a pig-exchange station with a plurality of pig sockets for pigs; a switchable pressure-tight pig connection with which the pig station is capable of being connected to the pig-exchange station and through which pigs are capable of being conveyed in both directions; at least one drive unit which is capable of being controlled by the control unit for connecting and disconnecting the pig connection to and from the pig station and the pig-exchange station; at least one coupling to a supply source for a pushing medium for conveying the at least one pig through the pig connection.

### CROSS-REFERENCE TO RELATED APPLICATIONS

This application claims priority to German Patent Application Number 10 2004 037 247.0, filed Jul. 31, 2004, which is incorporated herein by reference.

### DESCRIPTION

The invention relates to a supply unit for an application device, in particular for a lacquer-application device, with at least one pig which is capable of being conveyed in at least one pig line between at least two pig stations, and with at least one sensor for detecting the position of the at least one pig, which is connected to a control unit for controlling the supply unit.

The term ‘pig line’ in the present case is understood to mean a piggable line for media that are liquid, pasty or capable of flowing in some other way.

In addition, the invention relates to a process for operating a supply unit for an application device, in particular for a lacquer-application device, wherein at least one pig is conveyed in at least one pig line between at least two pig stations and the position of the at least one pig is detected with at least one sensor, in particular for the purpose of operating an apparatus according to the invention.

A process for supplying a lacquer-application device with lacquer is known from WO 2004/009247 A1, wherein pigs are conveyed back and forth between two pig stations in order to transport lacquers and cleaning agents through a pig line and to clean this pig line. The location of the pigs is detected with sensors, and the process is controlled by a control unit. In order to achieve optimal results and, particularly in the event of a change of ink, to remove ink residues in the pig lines in residue-free manner, the cylindrical surfaces of the pigs have to rest in contact with the internal cylindrical surfaces of the pig line in as fluid-tight a manner as possible in the course of conveying. This results in wear of the pigs. Since the quality of the cleaning and the efficiency of the transport of the ink and of the cleaning agent depend crucially on the state of the pigs, worn pigs have to be exchanged. In certain cases a change of pig may likewise become necessary in the event of frequent change of ink or in the event of a change between light and dark ink.

From DE 102 34 247 A1, an apparatus for measuring an operating parameter of a coating plant for objects is known with which the state and/or the location of pigs within a hose for conveying lacquers is monitored by using sensors.

The object of the present invention is to upgrade an apparatus and a process of the type specified in the introduction in such a way that during the operation of the application device, in particular in the event of a change of ink or if the pigs are worn, pigs are exchangeable without the application device or the supply unit having to be opened. Furthermore, an exchange of the pigs is to be possible cyclically in automatically controlled manner. In addition, several exchange operations are also to be capable of being implemented without manual intervention.

According to the invention, this object is achieved by means of an automatically controllable pig-exchange apparatus that exhibits the following components:

a) a pig-exchange station with a plurality of pig sockets for pigs;

b) a switchable pressure-tight pig connection with which the pig station is capable of being connected to the pig-exchange station and through which pigs are capable of being conveyed in both directions;

c) at least one drive unit, capable of being controlled by the control unit, for connecting and disconnecting the pig connection to the pig station and to the pig-exchange station; and,

d) at least one coupling to a supply source for a pushing medium for conveying the at least one pig through the pig connection.

According to the invention, an exchange of pigs is therefore possible without the application device having to be taken out of service and without the pig station having to be opened. The pigs are only exchanged between the pig station and the pig-exchange station. It is not necessary that the pig station is freely accessible for the operator, since the pigs are withdrawn from and supplied to the plant via the pig-exchange station, so that the pig station can remain integrated within the application apparatus. The pig-exchange station can, on the other hand, be installed separately from the pig station at a readily accessible location. Through the use of controllable drive units an exchange of pigs is possible automatically.

In an advantageous embodiment, the pig connection exhibits an opening unit for the pig line in the region of the pig station and a coupling unit leading to the pig station. This has the great advantage that only one structural unit is required in order to open the pig line and in addition to establish the connection to the pig-exchange station.

In this regard it is expedient if the pig line in the pig station opens into a passage opening for the at least one pig, if a removable sealing plug is arranged in the passage opening, if the coupling unit exhibits a displacement unit with a displacement drive, which is arranged on the pig station as an extension to the passage opening, the displacement unit exhibiting by way of opening unit a plug socket with a plug drive for the sealing plug and a pig-insertion cylinder adapted to the passage opening with a cylinder drive, and if the plug socket and the pig-insertion cylinder are optionally capable of being positioned in front of the passage opening by displacement, and if the pig-insertion cylinder is connected to the pig-exchange station via a pig hose. The passage opening can be sealed particularly simply in pressure-tight manner with the sealing plug and the pig-insertion cylinder. The exchange of the sealing plug for the pig-insertion cylinder can be undertaken particularly rapidly, since merely a single displacement of the displacement unit is required.

In a particularly preferred embodiment the pig-exchange station exhibits the following components:

a) at least one mobile pig magazine with at least two pig sockets which are capable of being optionally connected to a pig hose by movement of the pig magazine, and,

b) at least one magazine drive for the pig magazine, in order to change the assignment of the pig sockets to the pig hose.

In this way a separate pig socket may be provided for each pig. For example, use may be made of a separate pig for each ink, which is taken out of its pig socket in the event of a change of ink and is conveyed back inside in the event of a further change of ink. Several pigs for one ink may also be provided in various pig sockets, which can be exchanged in the event of wear. Operation of the device is consequently possible in maintenance-free manner also over a relatively long period without pigs having to be manually removed and new pigs having to be introduced. As a result, the maintenance effort and the costs are distinctly reduced.

In advantageous manner, at least one position-locking mechanism is provided for the purpose of fixing the pig magazine so that said magazine cannot be displaced during an exchange operation.

In another advantageous embodiment, sensors for detecting pigs are arranged on or in the pig-exchange station and/or the pig lines, as a result of which in the course of an automatic control the control unit can initiate a respective process step in accordance with the position of the pigs.

Sensors for determining the respective position of the components that are capable of being moved by drive units are preferably also provided, with which it is possible, in straightforward manner and without great technical effort, to establish when the corresponding drive unit has to be stopped. The respective pig sockets can also be identified by this means.

In advantageous manner at least one sensor is provided for determining a state of wear of the pig(s). With said sensor it is possible to determine precisely when an exchange of a worn pig has to be carried out.

With a sealable supply and discharge leading to the supply source for the pushing medium, in particular for compressed air, which are arranged on the pig station and on the pig-exchange station, the conveying direction for the respective pig can be predetermined. Compressed air presents itself for the reason that it introduces practically no contaminants into the system and can be released into the atmosphere.

In the process according to the invention, for the purpose of exchanging the at least one pig the following process steps are implemented in automatically controlled manner:

a) a pig connection between the pig station and the pig-exchange station is opened;

b) the at least one pig is conveyed out of the pig station through the pig connection to the pig-exchange station;

c) subsequently at least one new pig is conveyed out of the pig-exchange station through the pig connection to the pig station; and,

d) the pig connection is closed.

An exchange of pigs is accordingly carried out without the pig station having to be opened or perhaps removed. Consequently a rapid exchange of pigs is possible automatically.

In an advantageous configuration of the process, the pig connection is opened by a passage opening in the pig station being opened and simultaneously a pig hose leading to the pig-exchange station being indirectly or directly connected to the passage opening and by for the purpose of closing the pig connection the pig hose being separated from the passage opening and the passage opening being closed. By this means, a connection is capable of being established automatically between the pig station and the pig-exchange station with only three process steps.

In a particularly advantageous configuration of the process, the pig connection is opened by a sealing plug being conveyed out of the passage opening into a plug socket of a displacement unit and subsequently, in particular by means of a transverse displacement of the displacement unit, the sealing plug being removed from the passage opening and simultaneously a pig-insertion cylinder, which is likewise arranged in the displacement unit and which is connected to the pig-exchange station via a pig line, being arranged in front of the passage opening and subsequently being pushed into the passage opening. The passage opening in this case is always covered either by the sealing plug or by the pig-insertion cylinder, so that no separate plug is required in order to keep the pig in the pig line.

In another particularly advantageous configuration of the process, the at least one pig is supplied to an empty pig socket of a pig magazine of the pig-exchange station; subsequently the pig magazine and at least the part of the pig connection leading into the pig magazine are moved relative to one another in such a way that the pig connection is connected to another pig socket of the pig magazine containing at least one other pig. In order to move the pig magazine in such a way, only a simple drive unit is necessary, which merely has to be activated via a start signal and a stop signal.

In expedient manner the pig magazine is displaced relative to the pig connection, so that use can be made of a linearly constructed pig magazine which requires little installation space and can be realised without great technical effort.

In the event of a further exchange it is particularly advantageous to convey the at least one pig into the same pig socket of the pig magazine from which it was withdrawn in the preceding exchange operation. In this way the number of pig sockets required can be kept low. In addition, an exchange of pigs can be carried out rapidly with only one movement of the pig magazine.

In another advantageous configuration of the process, the exchange of pigs is carried out prior to a change of ink. This has the advantage that no mixing of ink residues is able to occur in the pig line. A separate cleaning of the pigs can be dispensed with. Use may also be made of special cleaning pigs with which, in the event of a change of ink, the cleaning of the pig line is carried out separately, and subsequently the transport of ink is effected with ink pigs.

It is particularly advantageous to carry out the exchange automatically as soon as the at least one pig is recognised by the control unit as being worn. In this way the frequency of exchange can be optimally adapted to the state of the pigs, as a result of which the frequency of maintenance is distinctly reduced.

### BRIEF DESCRIPTION OF THE DRAWINGS

An exemplary embodiment of the invention will be elucidated in more detail in the following on the basis of the drawing; shown are:

FIG. 1 schematically, a pig station with a pig connection to a pig-exchange station, in which the pig connection is closed;

FIG. 2 schematically, the pig station with the pig connection to the pig-exchange station, in which the pig connection is open.

### DETAILED DESCRIPTION OF THE DRAWINGS

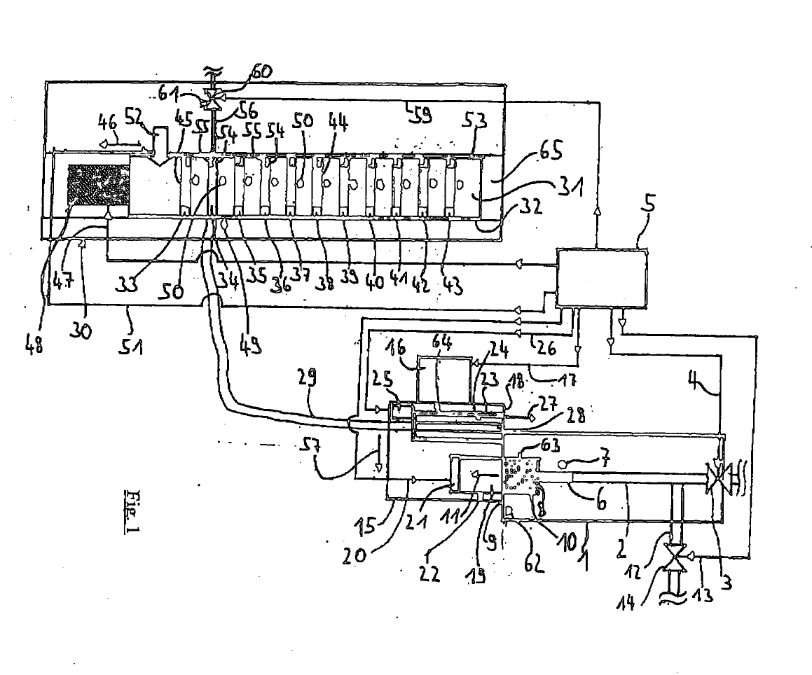

In FIG. 1 a pig station 1 is represented, by means of which a pig-station channel 2 is guided, the right end of which in FIG. 1 is connected to a pig line. The pig line is connected by its end facing away from the pig station 1, in a manner known as such, to a further pig station which is not represented. In the pig-station channel 2 a locking valve 3 is arranged which via a control line 4 is capable of being activated by a control unit 5.

Further couplings which are required for normal operation of the pig station 1, for example couplings for a pushing medium, cleaning liquid or a medium to be conveyed, are not represented and are known to a person skilled in the art.

In the pig-station channel 2 a displaceable pig 6 is represented in a parked position at the end of the pig-station channel 2 within the pig station 1. In the vicinity of the parked position a sensor 7 is arranged which is connected to the control unit 5 by radio and with which it is possible to detect whether the pig 6 is in the parked position. The pig-station channel 2 leads coaxially into a cylindrical passage opening 8 of the pig station 1. The passage opening 8 leads to a frontal region 9 of the pig station 1. The axis of the passage opening 8 is oriented in the direction of the pig-station channel 2. The passage opening 8 is sealed with a cylindrical sealing plug 10 which is capable of being removed away from the pig-station channel 2 in the direction of the arrow 11.

Once the sealing plug 10 has been removed, the pig 6 is likewise capable of being removed from the pig station 1 through the passage opening 8. In the vicinity of the passage opening 8 a sensor 63 is arranged which is connected to the control unit 5 by radio and with which the presence of the sealing plug 10 is capable of being detected.

Between the passage opening 8 and the locking valve 3 a compressed-air line 12 opens into the pig-station channel 2. The compressed-air line 12 leads, via a compressed-air valve 14 which is capable of being activated by the control unit 5 via a line 13, to a compressed-air supply source which is not represented. Via the compressed-air line 12 the pig-station channel 2 is capable of being supplied with compressed air.

On a flat frontal region 9 of the pig station 1 a displacement unit 15 is arranged outside the pig station 1 so as to be capable of being displaced relative to the passage opening 8. The displacement unit 15 is connected to a displacement drive 16 with which the displacement unit 15 is capable of being displaced, perpendicular to the course of the axis of the cylindrical passage opening 8, in the direction of an arrow 57, so that a transverse displacement of the displacement unit 15 is made possible. The displacement drive 16 is capable of being activated by the control unit 5 via a line 17.

The displacement unit 15 exhibits, in its likewise flat surface 18 facing towards the frontal region 9 of the pig station 1, a plug socket 19 in the form of a cylindrical bore which is adapted to the sealing plug 10. In the position of the displacement unit 15 that is represented, the plug socket 19 constitutes the extension of the passage opening 8, so that the sealing plug 10 is capable of being displaced into the plug socket 19 and capable of being totally sunk within said socket. On the plug socket 19 a plug drive 21 is arranged which is capable of being activated by the control unit 5 via a line 20, with which the sealing plug 10 can be moved into and out of the plug socket 19. The plug socket 19 and the plug drive 21 constitute, to a certain extent, an opening unit for the pig-station channel 2. The plug drive 21 is a pressure unit with which the plug socket 19 is optionally capable of being subjected to an overpressure or an underpressure. By means of an underpressure the sealing plug 10 is capable of being drawn into the plug socket 19, and by means of an overpressure it is capable of being pressed out of it. In the vicinity of the plug socket 19 there is arranged a sensor 22 which is connected to the control unit 5 by radio and with which it is possible to detect whether the sealing plug 10 is located in the plug socket 19.

Furthermore, the displacement unit 15 exhibits a cylinder guide 23 in the form of a cylindrical bore emanating from its surface 18, which is arranged alongside the plug socket 19. The axis of the cylinder guide 23 extends parallel to the axis of the cylindrical bore of the plug socket 19. The cross-section of the cylinder guide 23 corresponds to the cross-section of the passage opening 8.

In the cylinder guide 23 a pig-insertion cylinder 24 is arranged so as to be capable of being displaced along the axis of the cylinder guide 23. The pig-insertion cylinder 24 is connected to a cylinder drive 25, with which it can be displaced axially in the direction of, and in the opposite direction to, an arrow 27. The cylinder drive 25 is capable of being controlled by the control unit 5 via a line 26. With a cylinder sensor 64 in the vicinity of the cylinder guide 23 the presence of the pig-insertion cylinder 24 is capable of being detected and capable of being communicated by radio to the control unit 5. In the interior of the pig-insertion cylinder 24 an uninterrupted pig channel 28 extends coaxially with the axis of said cylinder, said pig channel being open to each of the end faces of the pig-insertion cylinder 24. The inner cross-section of the pig channel 28 is adapted to the outer cross-section of the pig 6 in such a way that the pig 6 is capable of passing through the pig channel 28. The outer cross-section of the pig-insertion cylinder 24 is adapted to the inner cross-section of the passage opening 8, so that a pressure-tight connection can be realised by pushing the pig-insertion cylinder 24 into the passage opening 8.

At its end pointing away from the pig station 1 the pig channel 28 is connected to a pig hose 29, the inner cross-section of which likewise corresponds to the outer cross-section of the pig 6. The pig hose 29 is at least so flexible that it adapts to the displacement of the displacement unit 15.

The pig hose 29 leads out of the displacement unit 15 to a pig-exchange station 30 and opens there into a pig magazine 31 in pressure-tight manner.

The pig magazine 31 is a right-parallelipipedal body which exhibits along its long surface 32 facing towards the pig hose 29 identical cylindrical continuous bores by way of pig sockets 33 to 43 arranged alongside one another in a row. The inner cross-section of the bores corresponds to the outer cross-section of the pig 6. According to FIG. 1, the pig hose 29 opens into the empty pig sockets 34 in a direction perpendicular to the surface 32. The axis of the pig socket 34 is oriented in such a way that the pig socket 34 constitutes a stepless extension of the pig hose 29.

In the representation, the pig sockets 33 and 35 to 43 each contain a pig 45 and 44, respectively, for a variety of inks.

The pig magazine 31 is displaceably arranged in a magazine channel 65 in the pig-exchange station 30 in its longitudinal direction perpendicular to the axis of the pig sockets 33 to 43 in the direction of an arrow 46. In this way each of the pig sockets 33 to 43 can be optionally assigned to the pig hose 29. The displacement of the pig magazine 31 is brought about by means of a magazine drive 48 which is capable of being controlled by the control unit 5 via a line 47.

In the vicinity of the opening of the pig hose 29 into the pig magazine 31 a sensor 49 is arranged, with which it is possible to detect whether the pig magazine 31 is correctly positioned and the pig socket 34 is coupled to the pig hose 29 in flush manner. The sensor 49 is connected to the control unit 5 by radio. In the vicinity of each of the pig sockets 33 to 43 a further sensor 50 is respectively arranged, with which it is detected whether the respective pig socket is empty or filled with a pig 44 or 45. The sensors 50 are likewise connected to the control unit 5 by radio.

In order to fix the pig magazine 31 in the chosen position, a detachable position-locking mechanism 52 which is capable of being activated by the control unit 5 via the line 51 is provided on the pig magazine 31. The position-locking mechanism 52 has the function of a brake which presses on the face 53 of the pig magazine 31 situated opposite the surface 32.

The pig sockets 33 to 43 each exhibit, in an end 54 situated opposite the pig hose 29, a stop 55 with which the pigs 44 or 45 are prevented from slipping out of the respective pig socket. A compressed-air channel 56 which is connected to the pig socket 34 in pressure-tight manner leads to the end 54 of the pig socket 34 chosen in the given case. The compressed-air channel 56 is a continuous bore in the pig-exchange station 30, which leads from the surface of the pig-exchange station 30 facing away from the pig hose 29 to the magazine channel 65. The compressed-air channel 56 is stationary relative to the pig hose 29 and is, just like the pig hose 29, assigned to the pig socket 34 chosen in the given case in the event of a displacement of the pig magazine 31. The end of the compressed-air channel 56 facing away from the pig socket 34 is connected to a supply source for compressed air, which is not represented and which is known as such. With compressed air a pig which is not represented here can be conveyed out of the pig socket 34 chosen in the given case into the pig hose 29. The compressed-air channel 56 furthermore exhibits a compressed-air valve 60 which is capable of being activated by means of the control unit 5 via the line 59 and with which the supply of compressed air is capable of being regulated.

The compressed-air valve 60 exhibits, in addition, an outlet valve 61 which is capable of being activated and by which, in the open state, compressed air is able to escape from the respective pig socket 33 to 43.

Furthermore, the apparatus exhibits sensors, not represented, with which the state of wear of the pigs 6, 44, 45 is capable of being detected and the mode of operation of which is known as such to a person skilled in the art from DE 102 34 247 A1.

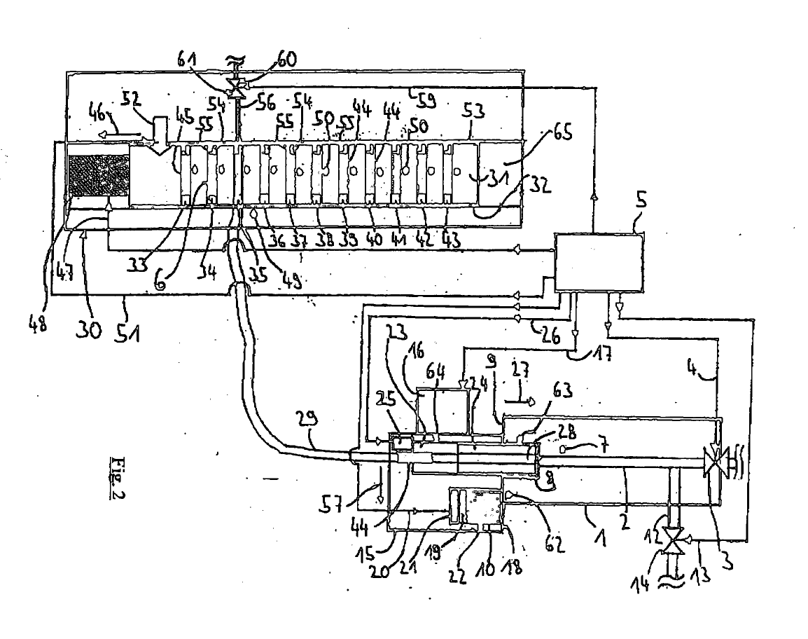

In FIG. 2 the same apparatus as in FIG. 1 is represented during an exchange of pigs. The pig-insertion cylinder 24 here has been pushed into the sealing opening 8, the worn-out pig 6 is already located in the pig socket 34, the pig hose 29 is assigned to the next pig socket 35, and the corresponding new pig 44 is already located in the pig hose 29 on the way to the pig station 1.

In the following an exchange of pigs will now be described, starting from the initial situation represented in FIG. 1.

As soon as the control unit 5 receives, in a manner known as such, the information from the application device, which is not represented, that a change of ink is being carried out or that the pig 6 is worn and therefore needs to be exchanged, the pig 6 is firstly conveyed, in a manner known as such, into the pig-station channel 2, into its parked position in front of the sealing plug 10. The attaining of the parked position is detected by the sensor 7 and communicated to the control unit 5. Then the sealing plug 10 is conveyed by the plug drive 21, started by the control unit 5, out of the passage opening 8 into the plug socket 19 in the direction of the arrow 11. The presence of the sealing plug 10 is detected there by the sensor 22, and the plug drive 21 is stopped by the control unit 5.

Thereupon the control unit 5 starts the displacement drive 16, in order to displace the displacement unit 15 in the direction of the arrow 57. By virtue of this transverse displacement of the displacement unit 15 at right angles to the pig station 1, the cylinder guide 23 and the pig-insertion cylinder 24 are displaced in the direction of the passage opening 8 and simultaneously the sealing plug 10 is removed from the passage opening 8. As soon as a sensor 62 which is connected to the control unit 5 by radio detects that the cylinder guide 23 has been positioned in front of the passage opening 8, the control unit 5 stops the displacement drive 16.

Subsequently the cylinder drive 25 is started by means of the control unit 5, in order to push the pig-insertion cylinder 24 into the passage opening 8 as far as the pig-station channel 2. As soon as the sensor 63 detects that the desired position has been attained, the cylinder drive 25 is stopped by means of the control unit 5. The pig channel 28 and the coupled pig hose 29 now constitute an extension of the pig-station channel 2.

The valve 14 of the compressed-air line 12 is now activated in opening manner, and simultaneously the sealing valve 3 for the pig-station channel 2 is activated in closing manner, so that compressed air reaches the pig 6. In addition, the outlet valve 61 is activated in opening manner. With the compressed air the pig 6 is now conveyed through the continuous connection from the pig-station channel 2 through the pig channel 28 leading to the pig hose 29 into the empty pig socket 34 in the pig magazine 31. As soon as the pig 6 has arrived in the empty pig socket 34, this is detected by the sensor 50 assigned to the pig socket 34, and the compressed-air valve 14 is activated in closing manner and the sealing valve 3 of the pig-station channel 2 is activated in opening manner, so that the region upstream of the pig-station channel 2 up as far as the pig socket 34 is again pressure-free.

After this, the position-locking mechanism 52 of the pig magazine 31 is activated, so that said mechanism is released. Now the drive unit 19 is started by means of the control unit 5, in order to displace the pig magazine 31 in the direction of the arrow 46 to the next pig socket 35 which is filled with a new pig 44. As soon as the pig socket 35 has been connected to the pig hose 29, this is detected by the sensor 49, and the control unit 5 stops the magazine drive 48. After this, the outlet valve 61 is activated in closing manner and the compressed-air valve 60 is activated in opening manner, so that compressed air is able to flow to the pig socket 35. The new pig 44 is now conveyed by compressed air through the pig hose 29 and the pig channel 28 into the pig-station channel 2. The pig socket 35 is now empty and ready for the re-acceptance of the pig 44 as soon as the latter is exchanged in the course of the next exchange cycle. The situation that now obtains is represented in FIG. 2.

Upon arrival of the pig 44 in the pig-station channel 2, this is detected by the sensor 7. Thereupon the compressed-air valve 60 is controlled in closing manner.

After this, the cylinder drive 25 is activated, in order to pull the pig-insertion cylinder 24 out of the passage opening 8 back into the cylinder guide 23. As soon as the pig-insertion cylinder 24 has been totally sunk within the cylinder guide 23, said cylinder is detected by the cylinder sensor 64, whereupon the cylinder drive 25 is stopped. Now the displacement drive 16 is activated, which thereupon displaces the displacement device 8, contrary to the direction of the arrow 57, along the front face 9 of the pig station 1 back again to its initial position. As soon as the sealing plug 10 has been repositioned in front of the passage opening 8, this is detected by the sensor 62, and the displacement drive 16 is stopped. Thereupon the plug drive 21 is started which pushes the sealing plug 10 back into the passage opening 8. The attaining of the end position of the sealing plug 10 is detected by the sensor 63, whereupon the plug drive 21 is stopped. The pig-station channel 2 is now sealed again in the direction of the displacement device 15. The new pig 44 is now capable of being inserted in a manner known as such.

Instead of the sealing plug 10, use may also be made of another sealing device, for example a terminating plate that is capable of being displaced in a direction perpendicular to the pig-station channel 2.

The frontal region 9 may be flat or curved. It may, for example, take the form of a segment of a spherical surface, on which the displacement unit 15 can be displaced in positive manner. In this case the axes of the cylinder guide 23 and of the plug socket 19 should not be arranged in parallel. It is also sufficient if merely regions around the opening of the plug socket 19 and of the cylinder guide 23 are adapted to the passage opening 8 in such a way that in the corresponding position of the displacement unit 15 they are each connected to the passage opening 8 in stepless manner.

The displacement unit may also be constructed in the form of a drum, so that the plug socket and the cylinder guide are positioned onto the passage opening 8 by rotation of the drum instead of by transverse displacement.

It is to be understood that the pig magazine may also be constructed in a form other than linear. Use may also be made here of a round arrangement, for example drum-shaped, similar to a drum of a drum turret. The pig magazine may also be realised in the form of a belt, for example in the form of an endless loop on which the pig sockets are fastened side by side in the form of sleeves.

Each pig socket may also have its own compressed-air channel which can be opened and closed separately via a separate valve. Instead of the compressed air, an underpressure may also be employed for the purpose of conveying the pigs. A different pushing medium, for example a liquid, may also be employed.

Several pigs may also be provided for the same ink in various pig sockets, which can be exchanged in the event of wear.

By way of position-locking mechanism, use may also be made of a bolt which, for the purpose of fixing, can be pushed into appropriately arranged holes in the pig magazine. But the position-locking mechanism may also be integrated into the magazine drive.

The connections of the control unit 5 to the sensors, drives and valves may be realised both via lines and via radio links.

The drives may be realised in the form of motors, in the form of magnetic actuators, or even in the form of pressure-generating units.

While specific embodiments have been illustrated and described herein, numerous modifications may come to mind without significantly departing from the spirit of the invention, and the scope of protection is only limited by the scope of the accompanying Claims.

What is claimed is:

1. A supply unit for an application device with at least one pig which is capable of being conveyed in at least one pig line between at least two pig stations, and with at least one sensor for detecting the position of the at least one pig, which is connected to a control unit for controlling the supply unit, characterised by an automatically controllable pig-exchange device comprising:
a pig-exchange station including a plurality of pig sockets for pigs;
a switchable pressure-tight pig connection with which one of the at least two pig stations is capable of being connected to the pig-exchange station and through which pigs are capable of being conveyed in both directions;
at least one drive unit, capable of being controlled by the control unit, for connecting and disconnecting the pig connection to and from the one of the at least two pig stations and the pig-exchange station; and,
at least one coupling to a supply source for a pushing medium for the purpose of conveying the at least one pig through the pig connection.

2. The supply unit of claim 1, characterised in that the pig connection exhibits an opening unit for the pig line in the region of the one of at least two pig stations and a coupling unit leading to the one of at least two pig stations.

3. The supply unit of claim 2, characterised in that the pig line opens into a passage opening for the at least one pig, a removable sealing plug is arranged in the passage opening, the coupling unit exhibits a displacement unit with a displacement drive, which is arranged on the one of at least tow pig stations as an extension to the passage opening, the displacement unit exhibiting by way of opening unit a plug socket with a plug drive for the sealing plug and a pig-insertion cylinder adapted to the passage opening with a cylinder drive, and the plug socket and the pig-insertion cylinder are optionally capable of being positioned in front of the passage opening by displacement, and the pig-insertion cylinder is connected to the pig-exchange station via a pig hose.

4. The supply unit of claim 1, characterised in that the pig-exchange station comprising:
at least one mobile pig magazine with at least two pig sockets which are capable of being optionally connected to a pig hose by the movement of the pig magazine; and,
at least one magazine drive for the pig magazine, in order to change the assignment of the pig sockets to the pig hose.

5. The supply unit of claim 4, further comprising at least one position-locking mechanism for fixing the pig magazine.

6. The supply unit of claim 1, further comprising:
at least one sensor for detecting the pigs, the at least one sensor being arranged on or in the pig-exchange station or the at least one pig line.

7. The supply unit of claim 1, further comprising at least one sensor for determining a respective position of a component capable of being moved by a drive unit.

8. The supply unit of claim 1, further comprising at least one sensor for determining a state of wear of the pigs.

9. The supply unit of claim 1, characterised in that a sealable supply and discharge are operably coupled to the supply source for the pushing medium, and are operably connected to the pig station and the pig-exchange station.

10. For the supply unit of claim 1, a process for exchanging the at least one pig comprising the steps of:
opening a pig connection between the pig station and the pig-exchange station;
conveying at least one pig out of the pig station through the pig connection to the pig-exchange station;
conveying at least one new pig out of the pig-exchange station through the pig connection to the pig station; and,
closing the pig connection.

11. The process of claim 10, characterised in that the pig connection is opened by a passage opening in the pig station being opened and simultaneously a pig hose leading to the pig-exchange station being indirectly or directly connected to the passage opening and in that for the purpose of closing the pig connection the pig hose being separated from the passage opening and the passage opening being closed.

12. The process of claim 11, characterised in that the pig connection is opened by a sealing plug, which serves by way of a sealing means, being conveyed out of the passage opening into a plug socket of a displacement unit and subsequently, in particular by means of a transverse displacement of the displacement unit, by the sealing plug being removed from the passage opening and simultaneously a pig-insertion cylinder, which is likewise arranged in the displacement unit and which is connected to the pig-exchange station via a pig line, being arranged in front of the passage opening and subsequently being pushed into the passage opening.

13. The process of claim 10, characterised in that the at least one pig is supplied to an empty pig socket of a pig magazine of the pig-exchange station, in that subsequently the pig magazine and at least the part of the pig connection leading into the pig magazine are moved relative to one another in such a way that the pig connection is connected to another pig socket of the pig magazine containing at least one other pig.

14. The process of claim 13, characterised in that the pig magazine is displaced relative to the pig connection.

15. The process of claim 13, characterised in that in the event of a further exchange of the at least one pig, the latter is conveyed into the same pig socket of the pig magazine from which it was withdrawn in the preceding exchange operation.

16. The process of claim 10, characterised in that the exchange is carried out automatically prior to a change of ink.

17. The process of claim 10, characterised in that the exchange is carried out automatically as soon as the at least one pig is recognised by the control unit as being worn.
